(19) United States
(12) Patent Application Publication
(10) Pub. No.: US 2002/0129919 A1
(43) Pub. Date: Sep. 19, 2002

(54) Filter assembly

(75) Inventors: Philip Sandford, North Olmstead, OH (US); Richard B. Williams, Bay Village, OH (US); Brian E. Began, Broadview Hts., OH (US)

Correspondence Address: NIXON & VANDERHYE P.C., 8th Floor, 1100 North Glebe Road, Arlington, VA, 22201-4714, US

(73) Assignee: FOSECO INTERNATIONAL LIMITED.

(21) Appl. No.: 10/135,526

(22) Filed: May 1, 2002

Related U.S. Application Data
(63) Continuation of application No. 09/566,987, filed on May 9, 2000.
(60) Provisional application No. 60/134,616, filed on May 18, 1999.

(51) Int. Cl. B22D 35/00

(52) U.S. Cl. 164/134; 164/358

(57) ABSTRACT

A filter assembly for filtering molten metal poured into a mold includes a filter formed from refractory material, the filter having first and second porous surfaces through which molten metal may flow, and a peripheral surface and a locator attachable to at least one of the first, second and peripheral surfaces of the filter and arranged to extend from the at least one of the first, second and peripheral surfaces of the filter to another of the first, second and peripheral surfaces or to another part of those surface(s), during use. The locator locates the filter in a mold into which molten metal is poured.

### CROSS REFERENCE TO RELATED APPLICATION

This application is based upon U.S. Provisional Application Serial No. 60/134,616 filed May 18, 1999, the disclosure of which is hereby incorporated by reference herein.

### BACKGROUND AND SUMMARY OF THE INVENTION

The present invention relates to the filtration of molten metal, for example molten aluminium. In particular, the invention provides a filter assembly, a kit of parts for forming the filter assembly, and a mold including the filter assembly.

U.S. Pat. No. 4,708,326 (Swiss Aluminium Ltd) discloses a molten metal pouring cup which includes a filter and a resilient peripheral gasket surrounding a peripheral surface of the filter, which seals the filter to the pouring cup to prevent molten metal leakage around the filter.

U.S. Pat. No. 5,004,545 (Foseco International Ltd) discloses a ceramic foam filter having its peripheral surface surrounded by a gasket made from fibrous material. Metallic foil is fixed to the gasket around the outer peripheral surface of the gasket.

The invention has identified a need to ensure that a filter is tightly and properly located in a mold while at the same time ensuring that the filter is not damaged during its insertion.

According to a first aspect, the present invention provides a filter assembly for filtering molten metal poured into a mold, comprising:

(a) a filter formed from refractory material, the filter having first and second porous surfaces through which molten metal may flow (i.e. filtration surfaces), and a peripheral surface; and

(b) locating means for assisting the positioning of the filter in a mold, the locating means situated on at least one of the first, second and peripheral surfaces of the filter and arranged to extend from the at least one of the first, second and peripheral surfaces of the filter to another of the first, second and peripheral surfaces or to another part of said surface(s), at least during use.

The locating means of the filter assembly is/are preferably attached to the first and/or second and/or peripheral surface of the filter, for example the locating means may be adhered to the surface(s), preferably by means of an adhesive or some other bonding means (e.g. fused to the surface(s), preferably during the formation of the filter).

According to a second aspect, the invention provides a kit of parts for forming a filter assembly, comprising:

(a) a filter formed from refractory material, the filter having first and second porous surfaces through which molten metal may flow, and a peripheral surface; and

(b) locating means adapted to be attached to at least one of the first, second and peripheral surfaces of the filter and arranged to extend from the at least one of the first, second and peripheral surfaces of the filter to another of the first, second and peripheral surfaces or to another part of said surface(s), during use. the locating means being adapted to locate the filter in a mold.

According to a third aspect, the invention provides a mold for casting metal, including an aperture through which molten metal may be poured into the mold, and a filter assembly according to the first aspect of the invention located in the aperture such that the locating means is situated between the peripheral surface of the filter and an inner surface of the aperture.

The filter assembly is preferably located on a ledge or other projection provided in the mold aperture.

When it is stated herein that the filter is located in a mold, or in an aperture in a mold, this includes the location of the filter directly in the mold (e.g. a permanent mold, such as a metal mold for aluminium) and also includes the location of the filter in a sleeve or pouring cup of a mold.

The invention has an advantage over known filters with peripheral gaskets, in that because the locating means is arranged to extend from one surface of the filter to another surface, or from part of one surface to another part of that surface, the edge or edges of the filter between such surfaces and/or regions between such parts of the surfaces, are normally protected during insertion of the filter in the mold. Additionally, it has been found that such arrangements can assist in the insertion of the filter in the mold, and retention of the filter in place in the mold during use.

In embodiments in which the locating means is/are situated on the first and/or second filtration surface(s) of the filter, the locating means is/are preferably situated on only a peripheral region of such surface(s). The major, inner, proportion of the first and/or second surface(s) of the filter therefore preferably remains exposed to receive the molten metal. Whether the or each locating means is situated on a filtration surface or a peripheral surface of the filter, the locating means may cover substantially all, or only part of, the peripheral surface(s) of the filter during use.

Thus far, reference has been made to “locating means” rather than a “gasket”. This is because, as indicated earlier, the inventors have found that fundamentally, the need is for a tight and correct location of the filter in the mold (in addition to protection of the filter) rather than necessarily the formation of a seal between the filter and the mold. However, while not normally essential, it is generally preferred for the filter to be sealed against the interior of the mold. It is therefore preferred for the locating means to comprise a gasket.

Preferred materials for the locating means include ceramic fibres, glass fibres, ceramic paper, and/or vermicular graphite. The locating means is preferably resiliently compressible and/or resiliently flexible.

As already mentioned, the filter is formed from refractory material. The filter is preferably a ceramic foam filter or a cellular ceramic filter.

In some preferred embodiments of the invention, part of the locating means extends outwardly from a surface on which it is situated, away from that surface and/or one or more other surface(s) of the filter, the locating means being flexible to enable it to be deformed into conforming contact with another part of the same surface or with one or more other surface(s) of the filter. For example, part of the locating means may extend outwardly from a filtration surface on which it is situated, away from the peripheral surface of the filter, the locating means being flexible to enable it to be deformed into conforming contact with the peripheral surface. This deformation may, for example, occur on insertion of the filter into the mold. The outwardly extending part of the locating means may, for example, comprise a plurality of flaps which may be deformed into conforming contact with the peripheral surface of the filter. Alternatively, the outwardly extending part of the locating means may be substantially continuous, and may be folded in one or more regions in order to accommodate the deformation.

The locating means may be situated on the surface of the filter which is the front surface during insertion of the filter into a mold. Alternatively, the locating means may be situated on the surface of the filter which is the back surface during insertion. Such surfaces may be the filtration surfaces of the filter, but especially for use with vertically parted moulds, such surfaces may comprise regions of the peripheral surface of the filter.

In alternative preferred embodiments of the invention, the locating means may already extend from a said surface on which it is located to another surface of the filter, or to another part of the same surface, such that part of the locating means covers at least part of the other surface, or the other part of the same surface, of the filter (i.e. the locating means may be pre-deformed). As with the previous embodiment, the part of the locating means which covers the other surface or part of the filter may comprise a plurality of flaps, or alternatively it may be substantially continuous, and may be folded in one or more regions in order to accommodate the pre-deformation.

Advantageously, in embodiments in which part of the locating means covers at least part of the peripheral surface of the filter, such part of the locating means may be doubled back on itself such that it has a generally V- or U-shaped cross-section. The locating means may be any conventional device that is capable of properly (as described above) positioning the filter in the mold.

The first and second surfaces of the filter are preferably substantially planar and substantially mutually parallel. The peripheral surface of the filter may be substantially perpendicular to the first and second surfaces of the filter. The filter may, for example, have a substantially right cylindrical shape, the first and second surfaces being substantially circular. Alternatively, the peripheral surface of the filter may be at an oblique angle with respect to the first and second surfaces of the filter. The filter may, for example, have a substantially frusto-conical shape, the first and second surfaces being substantially circular.

According to another aspect of the invention there is provided a method of casting metal in a mold having an aperture through which molten metal may be poured, and utilizing a filter assembly for filtering molten metal poured into the mold, the filter assembly comprising: a filter formed from refractory material, the filter having first and second porous surfaces through which molten metal may flow, and a peripheral surface; and locating means for assisting the positioning of the filter in the mold. The method comprises (a) positioning the locating means so that it is situated on at least one of the first, second and peripheral surfaces of the filter and extends from the at least one of the first, second and peripheral surfaces of the filter to another of the first, second and peripheral surfaces or to another part of said surface(s) during use; and (b) pouring molten metal (e.g. aluminum, or containing aluminum) through the filter so that it flows through the aperture and into the mold to form a cast metal element.

According to another aspect of the invention there is provided a mold for casting metal including: A mold body having an aperture through which molten metal may be poured into a mold cavity in the mold body. A filter of refractory material having first and second molten metal-porous surfaces and a peripheral surface. And a gasket which is attached to at least one said surface of the filter and extends to another of said surfaces and which positions the filter in the mold so that molten metal flowing through the mold aperture flows through the filter first and second surfaces.

### BRIEF DESCRIPTION OF THE DRAWINGS

The invention will now be described by way of example, with reference to the accompanying drawings, of which:

FIG. 1 shows plan and cross-sectional views of a filter assembly according to the invention;

FIG. 2 shows a cross-sectional view of an alternative filter assembly according to the invention;

FIG. 3 shows plan and cross-sectional views of another filter assembly according to the invention;

FIG. 4 shows a side view of a further filter assembly according to the invention;

FIG. 5(a) to (d) shows four further embodiments of filter assembly according to the invention;

FIG. 6(a) to (e) shows five further embodiments of filter assembly according to the invention; and

FIG. 7(a) and (b) shows two further embodiments of filter assembly according to the invention.

### DETAILED DESCRIPTION OF THE DRAWINGS

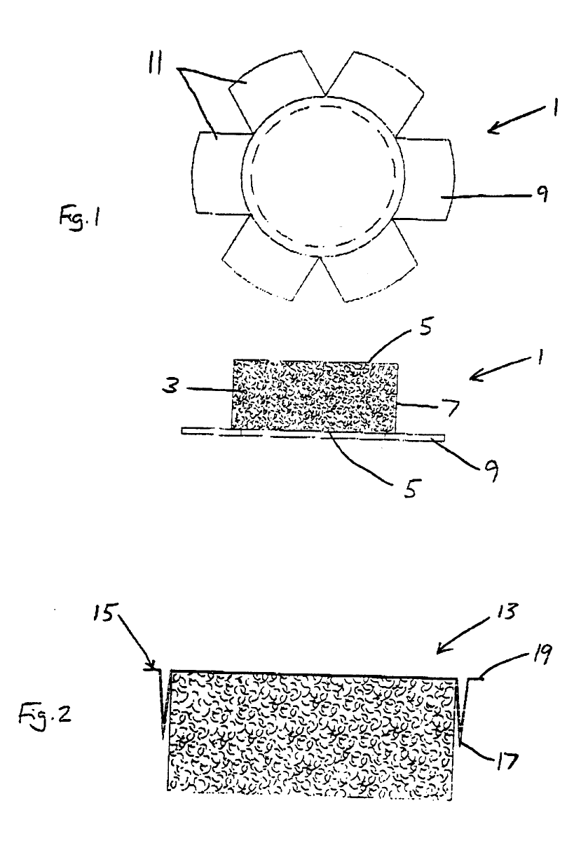

FIG. 1 shows one embodiment of a filter assembly 1 according to the invention, comprising a right cylindrical ceramic foam filter 3 having first and second circular (filtration) surfaces 5 and a peripheral surface 7, and a locating means—in this case a gasket 9—attached to one of the circular filtration surfaces of the filter. (By “filtration surface” is meant a surface of the filter through which molten metal will flow, in use.) The gasket 9 is generally in the form of a ring and has an internal diameter which is slightly smaller, and an external diameter significantly larger, than the external diameter of the filter. The gasket 9 is therefore attached to the filter 3 only in a peripheral (i.e. radially outward) region of the filtration surface of the filter.

The region of the gasket 9 which projects outwardly from the filter comprises a plurality (six, as drawn) of flaps 11. The gasket is flexible, and the flaps may be deformed around the circular edge of the filter into conforming contact with the peripheral surface of the filter; this deformation of the gasket may be carried out before the filter is inserted into a mold, but preferably it occurs automatically upon insertion. At least during use, therefore, the gasket extends from the circular filtration surface of the filter (to which it is attached), to the peripheral surface of the filter. This protects the filter, and especially its vulnerable leading peripheral edge, during insertion of the filter into a mold aperture (whether this is directly into a permanent mold, for example, or into a sleeve or pouring cup of a sand mold, or the like).

In addition to being flexible, the gasket is also resilient, in particular it is both resiliently flexible and resiliently compressible. These two physical characteristics of the gasket enable it to form a tight seal between the filter and the inner surface of a mold aperture during use. They also enable such a seal to be formed despite variations in the dimensions of mold apertures within a set of moulds, and variations in the dimensions of filters within a batch of filters (i.e. manufacturing tolerances).

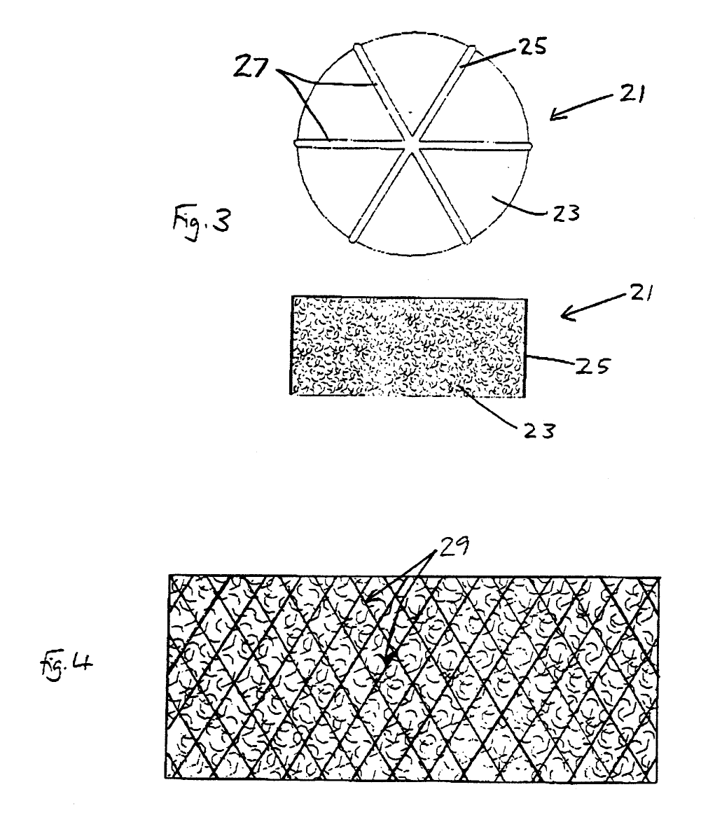

FIG. 2 shows a filter assembly 13 according to the invention which is similar to that shown in FIG. 1, but which has a modified design of gasket. The gasket 15 of this assembly is also attached to a peripheral region of a filtration surface of the cylindrical filter, and the gasket projects outwardly from the filter. Although not shown in the drawing, the outwardly projecting region of the gasket comprises a plurality of flaps similarly to the gasket of FIG. 1. However, in this case each flap extends generally adjacent to the peripheral surface of the filter and contains a fold 17 such that it is doubled back on itself and has a generally V-shaped cross-section. This V-shaped arrangement provides a particularly effective seal for a range of sizes of mold aperture, i.e. it provides good “range-taking”. The radially outward extremity 19 of each gasket flap is also folded such that it lies generally in the same plane as the filtration surface of the filter; this may, for example, provide a means of location with a ledge or lip of a mold aperture to aid the seating of the filter.

FIG. 3 shows, in plan and cross-sectional views, another type of filter assembly 21 according to the invention. In this case, however, although the filter 23 has a right cylindrical shape, the assembly does not include a gasket as such, but rather a “locating means” 25 in the form of a plurality of elongate strands 27 extending radially from the centre of one of the circular filtration surfaces of the filter. Each strand 27 extends around the edge of the filter and lies in conforming contact with its peripheral surface, in an orientation parallel to its axis. These strands assist in the location of the filter in a mold aperture, and also serve to protect the filter, especially its leading peripheral edge, during insertion into the aperture.

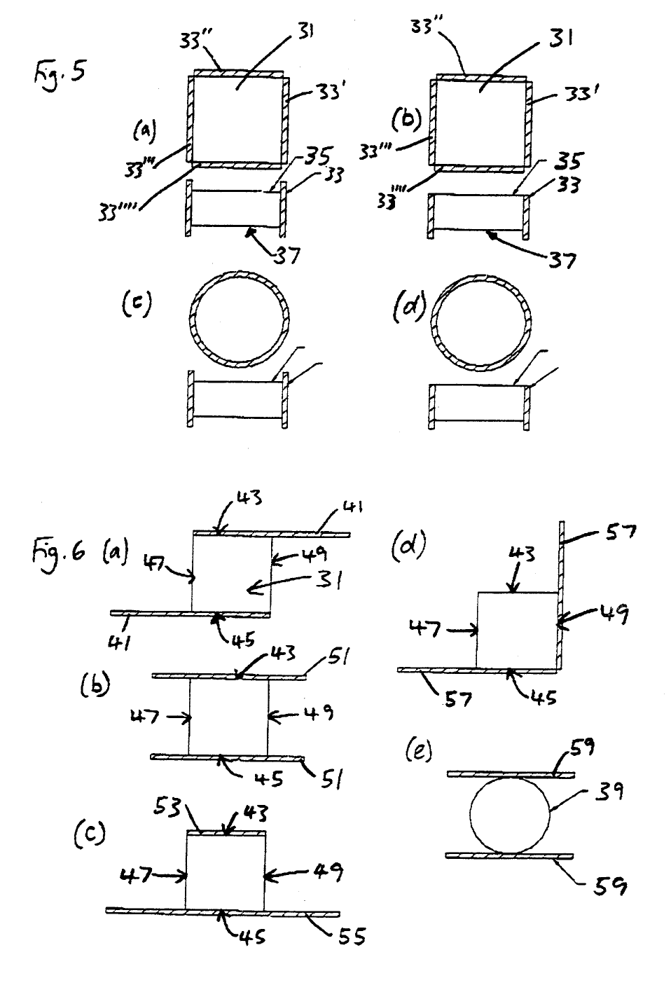

FIG. 4 shows, in side view, a modification of the filter assembly shown in FIG. 3, in which the locating means is in the form of a net-like structure 29 which has been wrapped around the entire filter, i.e. both filtration surfaces and the peripheral surface of the filter. Because, in the filter assemblies of both FIG. 4 and FIG. 3, the locating means are in the form of a plurality of elongate strands or a net-like structure, they provide no significant impediment to the flow of molten metal through the filtration surfaces of the filter. The locating means of FIGS. 3 and 4 may, for example, be formed from glass fibres, or other fibres having characteristics similar to those of glass fibres.

FIG. 5, in views (a) to (d), shows four further embodiments of filter assembly according to the invention. Embodiments (a) and (b) comprise square cross-section filters 31, and gaskets 33 attached to the peripheral surface of the filters, around the entire periphery of the filters. In assembly (a), the gasket 33 extends beyond both filtration surfaces 35 and 37, whereas in assembly (b), the gasket 33 extends beyond only one of the two filtration surfaces, namely surface 37. In both assemblies, the gasket 33 actually comprises four separate gasket parts 33′, 33″, 33′″ and 33″″, each part being attached to a respective face of the peripheral surface of the square cross-section filter. Alternatively, however, in both cases the gasket 33 could be formed from a single part, or from any convenient number of separate parts.

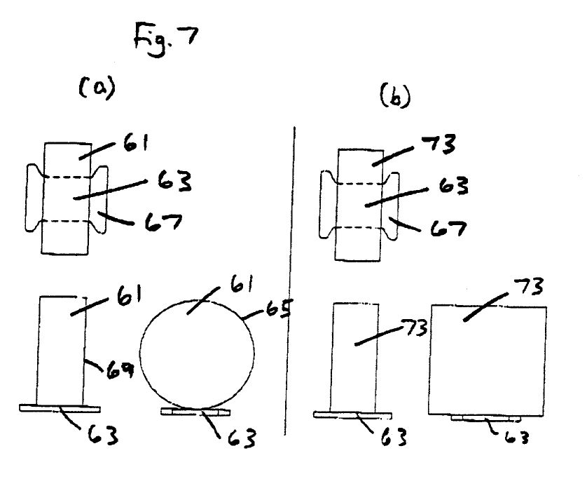

FIG. 6, views (a) to (e), shows five further embodiments of filter assembly according to the invention. In each of these embodiments, the gaskets are attached to only part of the peripheral surface of the filter, and extend away from the filter. The gaskets are flexible, and are arranged to be deformed into conforming contact with respective other parts of the peripheral surface of the filter during use, for example upon insertion into a mold aperture. Such embodiments are particularly suitable for use with vertically parted molds, for example.

More specifically, the embodiments shown in FIG. 6(a) to (d) each comprise a square cross-section filter 31, whereas the embodiment shown in FIG. 6 (e) comprises a circular cross-section filter 39. Embodiment (a) has a pair of gaskets 41 attached to opposite faces 43 and 45 of the filter, the gaskets extending away from the filter in opposite directions, i.e. beyond opposite faces 47 and 49 of the peripheral surface of the filter. In embodiment (b), there are two gaskets 51, attached to opposite faces 47 and 49 of the peripheral surface filter, but in this embodiment each gasket extends beyond both opposite faces 43 and 45 of the peripheral surface of the filter. Embodiment (c) is a variant in which one of the gaskets 53 does not extend away from the filter, but the other gasket 55 extends away from both opposite faces 47 and 49 of the peripheral surface filter. Embodiment (d) is a further variant in which the two gaskets 57 are attached to adjoining faces 45 and 49 of the peripheral surface of the filter, and extend beyond faces 47 and 43, respectively, of the peripheral surface of the filter at right angles to each other. In embodiment (e), two gaskets 59 are attached to diametrically opposite sides of the circumference of the circular cross-section filter, and each gasket extends away from the filter in two opposite directions. In all embodiments, the part of the gasket which extends away from the filter is arranged to be deformed into conforming contact with a respective part of the peripheral surface of the filter during use, for example during insertion of the filter assembly in a mold aperture.

FIG. 7 shows two further embodiments of filter assembly according to the invention. FIG. 7(a) shows a cylindrical filter 61 having a generally “I”-shaped gasket 63 attached to part of the circumferential surface 65 of the filter. Flap portions 67 of the gasket extend away from the circumferential surface 65, and are arranged to be deformed into conforming contact with filtration surfaces 69 and 71 of the filter. FIG. 7(b) shows a filter assembly similar to that of FIG. 7(a), the only difference being that the filter 73 has a square cross-section rather than a circular cross-section and the gasket 63 is attached to the peripheral surface of the filter on one side of the square.

While the invention has been herein shown and described in what is presently conceived to be the most practical and preferred embodiment thereof, it will be apparent to the those skilled in the art that many modifications may be made thereof within the scope of the invention, which scope is to be accorded the broadest interpretation of the appended claims to encompass all equivalent structures and methods.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A filter assembly for filtering molten metal poured into a mold, comprising:
(a) a filter formed from refractory material, the filter having first and second porous surfaces through which molten metal may flow, and a peripheral surface; and
(b) locating means for assisting the positioning of the filter in a mold, the locating means situated on at least one of the first, second and peripheral surfaces of the filter and arranged to extend from the at least one of the first, second and peripheral surfaces of the filter to another of the first, second and peripheral surfaces or to another part of said surface(s), at least during use.

2. An assembly according to claim 1, in which the locating means is attached to the at least one of the first, second and peripheral surfaces of the filter.

3. An assembly according to claim 2, in which the locating means is adhered to the at least one of the first, second and peripheral surfaces of the filter.

4. An assembly according to claim 1, in which the locating means is located on only a peripheral region of the first and/or second surface of the filter.

5. An assembly according to claim 1, in which part of the locating means extends outwardly from a said surface on which it is located, away from one or more other said surface(s) of the filter, the locating means being flexible to enable it to be deformed into conforming contact with the other surface(s) of the filter.

6. An assembly according to claim 5, in which the outwardly extending part of the locating means comprises a plurality of flaps which may be deformed into conforming contact with said other surface(s) of the filter.

7. An assembly according to claim 1, in which the locating means extends from the first and/or second surface of the filter to the peripheral surface of the filter such that part of the locating means covers at least part of the peripheral surface of the filter.

8. An assembly according to claim 7, in which the part of the locating means which covers at least part of the peripheral surface of the filter comprises a plurality of flaps.

9. An assembly according to claim 7, in which the part of the locating means which covers at least part of the peripheral surface of the filter is doubled back on itself such that has a generally V- or U-shaped cross-section.

10. An assembly according to claim 1, in which the locating means is resiliently compressible.

11. An assembly according to claim 1, in which the locating means is formed from ceramic fibres, glass fibres, ceramic paper, and/or vermicular graphite.

12. An assembly according to claim 1, in which the locating means comprises a gasket for forming a seal between the filter and an inner surface of a mold in which the filter is located in use.

13. An assembly according to claim 1, in which the first and second surfaces of the filter are substantially planar and substantially mutually parallel.

14. An assembly according to claim 13, in which the peripheral surface of the filter is substantially perpendicular to the first and second surfaces of the filter.

15. An assembly according to claim 14, in which the filter has a substantially right cylindrical shape, the first and second surfaces being substantially circular.

16. An assembly according to claim 13, in which the peripheral surface of the filter is at an oblique angle with respect to the first and second surfaces of the filter.

17. An assembly according to claim 16, in which the filter has a substantially frusto-conical shape, the first and second surfaces being substantially circular.

18. A kit of parts for forming a filter assembly, comprising:
(a) a filter formed from refractory material, the filter having first and second porous surfaces through which molten metal may flow, and a peripheral surface; and
(b) locating means adapted to be attached to at least one of the first, second and peripheral surfaces of the filter and arranged to extend from the at least one of the first, second and peripheral surfaces of the filter to another of the first, second and peripheral surfaces or to another part of said surface(s), during use, the locating means being adapted to locate the filter in a mold.

19. A mold for casting metal, including an aperture through which molten metal may be poured into the mold, and a filter assembly according to claim 1 located in the aperture such that the locating means is situated between the filter and an inner surface of the aperture.

20. A mold according to claim 19, in which the filter assembly is located on a ledge provided in the aperture.

21. A mold according to claim 19, in which the locating means comprises a gasket which seals between the filter and the inner surface of the aperture.

22. A method of casting metal in a mold having an aperture through which molten metal may be poured, and utilizing a filter assembly for filtering molten metal poured into the mold, the filter assembly comprising: a filter formed from refractory material, the filter having first and second porous surfaces through which molten metal may flow, and a peripheral surface; and locating means for assisting the positioning of the filter in the mold; said method comprising:
(a) positioning the locating means so that it is situated on at least one of the first, second and peripheral surfaces of the filter and extends from the at least one of the first, second and peripheral surfaces of the filter to another of the first, second and peripheral surfaces or to another part of said surface(s) during use; and
(b) pouring molten metal (e.g. aluminum, or containing aluminum) through the filter so that it flows through the aperture and into the mold to form a cast metal element.

23. A mold for casting metal including:
a mold body having an aperture through which molten metal may be poured into a mold cavity in the mold body;
a filter of refractory material having first and second molten metal-porous surfaces and a peripheral surface; and
a gasket which is attached to at least one said surface of the filter and extends to another of said surfaces and which positions the filter in the mold so that molten metal flowing through the mold aperture flows through the filter first and second surfaces.
